(19) United States
(12) Patent Application Publication
(10) Pub. No.: US 2020/0241159 A1
(43) Pub. Date: Jul. 30, 2020

(54) VERTICAL SEISMIC PROFILING FORMATION VELOCITY ESTIMATION

(71) Applicant: Halliburton Energy Services, Inc., Houston, TX (US)

(72) Inventors: Mark Elliott Willis, Katy, TX (US); Amit Padhi, Houston, TX (US)

(73) Assignee: Halliburton Energy Services, Inc., Houston, TX (US)

(21) Appl. No.: 15/768,047

(22) PCT Filed: Aug. 3, 2017
(86) PCT No.: PCT/US2017/045364

§ 371 Date: Apr. 13, 2018

(51) Int. Cl. G01V 1/42; G01V 1/30

(52) U.S. Cl. CPC G01V 1/42; G01V 1/303; G01V 2210/161; G01V 2210/121; G01V 2210/6222; G01V 2210/322; G01V 2210/41

(57) ABSTRACT

A method for processing vertical seismic profiling (VSP) data is provided. The method includes receiving VSP data in response to seismic energy applied to the formation, processing a down-going portion of the VSP data associated with a down-going wave field, outputting a first set of estimation values based on processing the down-going portion of the VSP data, the first set of estimation values estimating at least one of slowness or velocity, processing an up-going portion of the VSP data associated with an up-going wave field, outputting a second set of estimation values based on processing the up-going portion of the VSP data, the second set of estimation values estimating at least one of slowness or velocity, and determining an estimation associated with the formation based on the first and second sets of estimation values.

### TECHNICAL FIELD OF THE INVENTION

The embodiments disclosed herein generally relate to the use of vertical seismic profiling (VSP) to obtain formation velocity estimation and, more particularly, to methods of processing zero offset VSP (ZOVSP) using multiple data sets to estimate formation velocity.

### BACKGROUND OF THE INVENTION

Hydrocarbons, such as oil and gas, are commonly obtained from subterranean formations that may be located onshore or offshore. The development of subterranean operations and processes involved in removing hydrocarbons from a subterranean formation are complex. Typically, subterranean operations involve a number of different steps such as, for example, drilling a wellbore through and/or into the subterranean formation at a desired well site, treating the wellbore to optimize production of hydrocarbons, and performing the necessary steps to produce and process the hydrocarbons from the subterranean formation. Some or all of these steps may require and utilize seismic/acoustic measurements and other sensed data to determine characteristics of the formation, the hydrocarbon, the equipment used in the operations, etc.

One example technique for obtaining seismic/acoustic data involves using VSP. VSP refers to the measurement of seismic/acoustic energy in a wellbore originating from a seismic source at the surface of the formation (e.g., a vibrator truck, air gun, weight drop, and/or explosives). Traditionally, measurements using VSP (i.e., VSP data) involve sampling a seismic wave field using a string of approximately equally spaced seismic/acoustic receivers such as geophones and/or hydrophones that are lowered into a wellbore. VSP sampling of a seismic wave field using geophones or hydrophones is typically limited to resolutions on the order of tens of feet.

An alternate method of VSP data collection may include the use of distributed acoustics sensing (DAS) techniques. In DAS VSP a fiber optic cable is deployed in the wellbore instead of geophones or hydrophones. Relative to VSP using geophones or hydrophones, DAS VSP provides simplified deployment that does not interfere with operations in the wellbore, allows acquisition of instantaneous measurement data along a length of the wellbore, and improves resolution. The ability to improve directionality of data obtained by seismic profiling, particularly for DAS VSP, is also of direct relevance to hydrocarbons removal from subterranean formations.

Zero offset VSP (ZOVSP) refers to a VSP technique in which data is collected with the seismic source disposed near the wellbore, for example, directly above the wellbore. ZOVSP can be obtained in an area where the geology has a flat, layer cake structure. Formation velocity is conventionally estimated using a single data set associated with the down-going wave field. Well-known algorithms are used to pick a first break time for each receiver (i.e., time for a wave to travel from the source directly down to the receiver), and a slope of the first break is determined, wherein the slope indicates time delays associated with slowness of the formation (which is the reciprocal of formation velocity). If a seismic source which primarily contains compression or P waves is used, then the formation P-wave velocity can be estimated from the first break picks.

Alternatively, if a seismic source containing primarily shear or S waves is used, then the formation shear wave velocity can be estimated from the first break picks. Thus, an estimation of the formation velocity can be derived from the slope determined for the first breaks of the down-going wave field. However, the up-going, reflected wave field, which is affected by the same time delays that indicate formation velocity, yet also susceptible to somewhat more noise than the down-going wave field, has not been used to estimate formation velocity. The VSP data associated with the up-going wave field has been untapped for formation velocity estimation. Additional data that has been untapped for velocity formation estimation includes VSP data associated with either the down-going or up-going wave fields that are associated with time windows other than the time associated with the first breaks.

Alternatively a walk above VSP geometry can be used, wherein the wellbore is not strictly vertical, but is deviated or even horizontal. In this case, multiple surface seismic source locations are selected to be sequentially directly above each receiver. In this way a walk above VSP survey attempts to mimic the geometry of a vertical well and a zero offset VSP by combining data collected with seismic sources on the surface located directly above each corresponding receiver location in the wellbore.

Accordingly, there is continued interest in the development of improved formation velocity estimation using untapped VSP data associated with the up-going wave field and time windows other than the time associated with the first breaks.

### BRIEF DESCRIPTION OF THE SEVERAL VIEWS OF THE DRAWING

For a more complete understanding of the disclosed embodiments, and for further advantages thereof, reference is now made to the following description taken in conjunction with the accompanying drawings in which:

FIG. 1 is a schematic diagram illustrating an example vertical seismic profiling (VSP) system according to the disclosed embodiments;

FIG. 2 is a schematic diagram illustrating an example VSP system deployed in association with a wellbore based on a zero offset configuration according to the disclosed embodiments;

FIG. 2A is a schematic diagram illustrating an example VSP system deployed in association with a wellbore based on a walk above configuration according to the disclosed embodiments;

FIG. 3 is a block diagram illustrating an exemplary information processing system, in accordance with embodiments of the present disclosure;

FIG. 4A is a schematic diagram that illustrates an example logging while drilling (LWD) environment;

FIG. 4B is a schematic diagram that illustrates an example wireline logging environment;

FIG. 5 is a plot of ZOVSP data associated with the down-going wave field in accordance with embodiments of the present disclosure;

FIG. 6 is an enlarged view of a selected area of the plot shown in FIG. 5 and a corresponding semblance in accordance with embodiments of the present disclosure;

FIG. 7 is a semblance using a slant stack linear moveout analysis of a sliding window of traces of the ZOVSP data associated with the down-going wave field shown in FIG. 5;

FIG. 8 is a plot of ZOVSP data associated with the up-going wave field in accordance with embodiments of the present disclosure;

FIG. 9 is a semblance using a slant stack linear moveout analysis of a sliding window of traces of the ZOVSP data associated with the up-going wave field shown in FIG. 8;

FIG. 10 is a plot of ZOVSP data associated with the up-going wave field that has been transformed to two-way time in accordance with embodiments of the present disclosure;

FIG. 11 is a semblance using a slant stack linear moveout analysis of a sliding window of traces of the ZOVSP data associated with the transformed, up-going wave field shown in FIG. 10;

FIG. 12 is a flowchart illustrating operations of a workflow for an NSGA II algorithm in accordance with embodiments of the present disclosure; and

FIG. 13 is a flowchart illustrating operations of a method performed by a processing system of a VSP system in accordance with embodiments of the present disclosure.

### DETAILED DESCRIPTION OF THE DISCLOSED EMBODIMENTS

The following discussion is presented to enable a person skilled in the art to make and use the invention. Various modifications will be readily apparent to those skilled in the art, and the general principles described herein may be applied to embodiments and applications other than those detailed below without departing from the spirit and scope of the disclosed embodiments as defined herein. The disclosed embodiments are not intended to be limited to the particular embodiments shown, but are to be accorded the widest scope consistent with the principles and features disclosed herein.

The terms “couple” or “coupled” as used herein are intended to mean either an indirect or a direct connection. Thus, if a first device couples to a second device, that connection may be through a direct connection, or through an indirect electrical or mechanical connection via other devices and connections. The term “uphole” as used herein means along a drill string or a hole from a distal end towards the surface, and “downhole” as used herein means along the drill string or the hole from the surface towards the distal end.

It will be understood that the term “oil well drilling equipment” is not intended to limit the use of the equipment and processes described with those terms to drilling an oil well. The terms also encompass drilling natural gas wells or hydrocarbon wells in general. Further, such wells can be used for production, monitoring, or injection in relation to recovery of hydrocarbons or other materials from a subsurface. This could also include geothermal wells intended to provide a source of heat energy instead of hydrocarbons.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

For purposes of this disclosure, an information processing system may include any device or assembly of devices operable to compute, classify, process, transmit, receive, retrieve, originate, switch, store, display, manifest, detect, record, reproduce, handle, or utilize any form of information, intelligence, or data for business, scientific, control, or other purposes. Examples of well-known computing systems, environments, and/or configurations that may be suitable for use with the information processing system include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices or any other suitable device that may vary in size, shape, performance, functionality, and price.

The information processing system may include a variety of computer system readable media. Such media may be any available media that is accessible by the information processing system, and it includes both volatile and non-volatile media, removable and non-removable media. The information processing system can include computer system readable media in the form of volatile memory, such as random access memory (RAM) and/or cache memory. The information processing system may further include other removable/non-removable, volatile/non-volatile computer system storage media, one or more processing resources such as a central processing unit (“CPU”) or hardware or software control logic, and/or ROM. Additional components of the information processing system may include one or more network ports for communication with external devices as well as various input and output (“I/O”) devices, such as a keyboard, a mouse, and a video display.

The information processing system may also include one or more buses operable to transmit communications between the various hardware components. A first device may be communicatively coupled to a second device if it is connected to the second device through a wired or wireless communication network which permits the transmission of information.

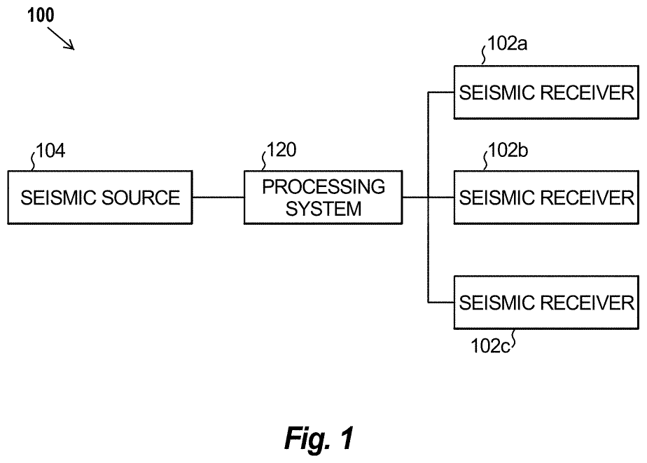

To facilitate a better understanding of the present disclosure, the following examples of certain embodiments are given. In no way should the following examples be read to limit, or define, the scope of the disclosure. Embodiments of the present disclosure and its advantages are best understood by referring to FIGS. 1-13, where like reference numbers are used to indicate like and corresponding parts.

Turning now to the drawings, FIG. 1 shows an illustrative example VSP system 100 according to the disclosed embodiments. The VSP system 100 can be used to analyze a subterranean formation using a VSP survey, such as in association with a geophysical survey using oil well drilling equipment. More particularly, the VSP system 100 may be used to estimate a velocity of the formation. The VSP system 100 may use both up-going and down-going wave fields to estimate the velocity of the formation, as opposed to just the down-going wave fields in more conventional systems. The VSP system 100 may simply average the velocity estimates from the up-going and down-going wave fields, or alternatively it may combine them in a more sophisticated way using an inversion process.

In an embodiment, the VSP system 100 may estimate the velocity of the formation using zero offset VSP data (which can be ZOVSP data, and which are used herein interchangeably) obtained for the formation. The VSP system 100 may estimate the velocity of the formation by processing a down-going portion of the ZOVSP data and outputting a first set of velocity estimations. The VSP system 100 may then process an up-going portion of the ZOVSP data and output a second set of velocity estimations. The first and second sets of velocity estimations may then be used to estimate a velocity of the formation.

A channel is associated with each seismic receiver. A trace is the VSP data recorded for one activation of one seismic receiver. In an embodiment, processing of the down-going portion of the ZOVSP data may comprise applying slant stack analysis to a range of channels associated with the down-going portion of the ZOVSP data, and processing of the up-going portion of the ZOVSP data may comprise applying slant stack analysis to the range of channels associated with the up-going portion of the ZOVSP data. In an embodiment, applying the slant stack analysis to the range of channels associated with the up-going portion of the ZOVSP data and the range of channels associated with the down-going portion of the ZOVSP data may include generating a semblance as a function of slope and time lag. The slope is slope of arrival times determined for the each trace in a ribbon of traces. The time lag is an arrival time at the first channel in the ribbon of channels being analyzed, which can be a first break at a first channel associated with the ribbon of traces.

The semblance is determined based on a summation of the arrival times over the time window of arrival times for each trace in the ribbon of traces, with the arrival times accounting for time lag associated with the slope for the trace.

The ribbon of traces includes the VSP data that corresponds to a ribbon of channels, each trace of the ribbon of traces corresponding to a channel of the ribbon of channels. The ribbon of channels is a subrange of channels of one range of channels. A new ribbon of traces is obtained each time the ribbon of channels is incrementally moved, also referred to as slid, along the range of channels.

As seen in FIG. 1, the VSP system 100 can include a processing system 120, one or more seismic receivers 102 communicatively coupled to the processing system 120, and one or more seismic sources 104 that apply seismic energy to an underground formation near a well head of the wellbore, in a configuration known as zero offset VSP (ZOVSP) (which is also referred to by those having skill in the art as near zero offset, since the actual placement of the seismic source is near the wellhead, as opposed to at the wellhead).

Each seismic source 104 (also termed a “shot”) is a device that generates controlled seismic energy and directs this energy into the underground formation. The seismic source 104 can generate seismic energy in a variety of ways, such as through an explosive device (e.g., dynamite or other explosive charge), an air gun, a “thumper truck,” a seismic vibrator, or other devices that can generate seismic energy in a controlled manner. Seismic sources 104 can provide single pulses of seismic energy or continuous sweeps of seismic energy.

The seismic receiver 102 (such as a geophone or hydrophone or distributed acoustic sensor) is a device used in seismic acquisition that detects ground velocity produced by seismic waves and transforms the motion into electrical impulses. Three seismic receivers 102 a-c are shown, referred to collectively as seismic receivers 102, without limitation to a specific number of seismic receivers. Seismic receiver 102 can detect motion in a variety of ways, for example through the use of an analog device (e.g., a sprint-mounted magnetic mass moving within a wire coil, or fiber optic cable detecting backscattered laser light) or a microelectromechanical (MEMS) device (e.g., a MEMS device that generates an electrical signal in response to ground motion through an active feedback circuit). The seismic receivers 102 output VSP data that corresponds to the detected motion.

The processing system 120 includes at least one processor (not expressly shown) that communicates with seismic receivers 102 and seismic sources 104 in order to send and receive information from seismic receivers 102 (including VSP data) and seismic sources 104, and to control the operation of seismic receivers 102 and seismic sources 104. The various processors of the processing system 120 can have different tasks related to collecting data, processing the data, and controlling the seismic sources 104 and seismic receivers 102 a-c. These processors can be physically and/or functionally distributed, operating either independently or cooperatively.

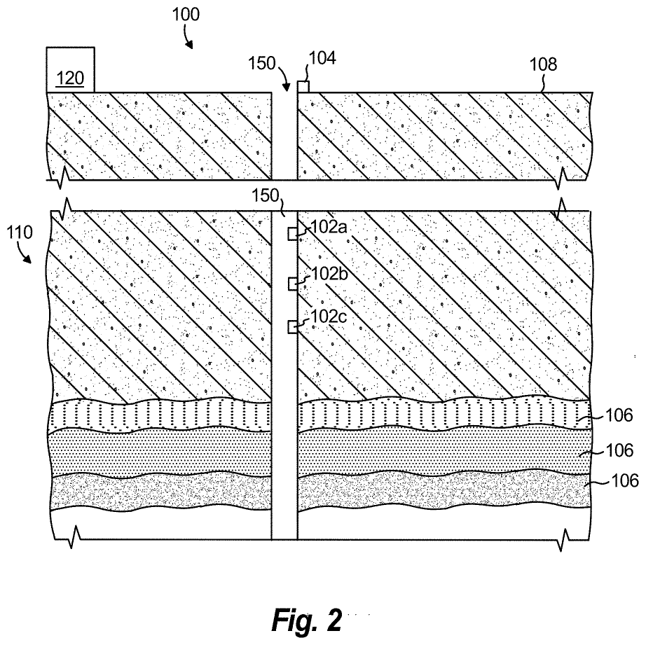

FIG. 2 shows an example physical arrangement for VSP system 100 based on a zero offset configuration. For a Zero Offset VSP (ZOVSP) data set (obtained in an area where the geology is flat or layer cake in structure), picking the time of the first breaks for every receiver allows for the velocity (or slowness) of the formation to be derived from the slope of these first breaks. It is well known that in this scenario the up-going, reflected wave field follows the same time delays as the down-going wave field as they propagate upwards toward the surface of the earth. However, the up-going wave field is not currently used in the determination of the formation velocity. The disclosed embodiments use both the down-going and up-going wave fields in estimating the formation velocity (or slowness).

As shown in FIG. 2, one or more seismic sources 104 are positioned on the surface 108 of the subterranean formation 110, while seismic receivers 102 a-c are positioned within a wellbore 150. When multiple seismic sources 104 are used, they are positioned near one another so that they can be treated as a single seismic source 104 for analysis purposes.

In some circumstances, subterranean formation 110 can be heterogeneous, and can include distributions of a variety of different media (e.g., rock, clay, sand, etc.). The formation 110 can include at least one interface 106 between different media. Seismic energy generated by the seismic sources 104 travels through the subterranean formation 110. Some of this energy is reflected and/or refracted by features in subterranean formation 110 (e.g., reflected by the least one interface 106). The seismic receivers 102 can sense the reflected and/or refracted seismic/acoustic energy and can output the sensed energy as VSP data. When the seismic receivers 102 are geophones or hydrophones, each respective seismic receiver 102 corresponds to a different channel. When the seismic receivers 102 include a DAS fiber optic receiver, the DAS fiber optic receiver includes a plurality of different channels along its length. Time-dependent information (i.e., time-dependent seismic “traces”) can be obtained from the VSP data and associated with a channel.

The propagation of seismic energy through a medium and generation of resultant seismic traces is dependent on various factors. For example, the velocity of propagation can be dependent on the properties of the medium, such as the medium's density, elasticity, and depth below the surface. Thus, seismic energy directed into subterranean formation 110 can propagate differently depending on the composition of subterranean formation 110.

The arrival time (or “travel time”) of seismic energy at a receiver 102 can also depend on the locations of the seismic sources 104, seismic receivers 102, and interfaces 106. In an example, seismic energy from a single seismic source 104 may have different arrival times to each of the seismic receivers 102 a-c, as each of the seismic receivers 102 a-c are located at a different depth below the surface 108. In another example, seismic energy from different seismic sources 104 may have different arrival times to each seismic receiver 102 a-c, as each seismic source 104 is located at a different point along the surface 108.

Seismic traces from each of the seismic receivers 102 a-c can be “migrated” based on information about known or predicted properties of the subterranean formation 110. Migration is a process in which each sample of an input seismic trace is mapped to an output image according to an image point within the subsurface. For example, seismic traces can be migrated by applying a velocity model that describes the behavior of seismic energy through the subterranean formation 110 based on known or predicted information about the composition of the subterranean formation 110. If the velocity model used for migration is accurate, when seismic traces are migrated, reflection events in resulting pre-stack migrated output or common image gathers (CIG) will be aligned properly, and a clear image of the subterranean formation can be created. However, if an inaccurate velocity model is used, the reflection events of the pre-stack, migrated output might not align, and the stacked image may be blurred or unclear.

In the example arrangement of FIG. 2, seismic sources 104 and seismic receivers 102 a-c are communicatively connected to processing system 120 through a communication interface (such as telemetry as described below). An example communication interface includes, for example, wired connectors and/or wireless transceivers.

The example arrangement for VSP system 100 shown in FIG. 2 is not necessarily drawn to scale. In general, components of VSP system 100 can be placed according to various physical geometries in order to analyze the subterranean formation. In an example geometry, seismic sources 104 are positioned along the surface 108 of the subterranean formation 110, seismic receivers 102 a-c are positioned at depths of 1000 m, 1500 m, and 3000 m below surface 108, respectively, and interface 106 is located at a depth of 2700 m below surface 108. It will be understood, however, that the seismic receivers 102 a-c and the interface 106 can be disposed or located at other depths or positions. In this example, the surface 108 of the subterranean formation 110 is on the surface of the earth. However, in some implementations, surface 108 may be on the sea floor, disposed below an overburden, or the like.

Embodiments of the present disclosure may be applicable to horizontal, vertical, deviated, multilateral, u-tube connection, intersection, bypass (drill around a mid-depth stuck object and back into the wellbore below), or otherwise nonlinear wellbores in any type of subterranean formation. Certain embodiments may be applicable to, for example, wired drillpipe, coiled tubing (wired and unwired), logging data acquired with wireline, slickline, and logging while drilling/measurement while drilling (LWD/MWD). Certain embodiments may be applicable to subsea and/or deep sea wellbores. Embodiments described below with respect to one implementation are not intended to be limiting.

Modifications, additions, or omissions may be made to FIG. 2 without departing from the scope of the present disclosure. For example, the VSP system 100 may be used with wireline, DAS VSP, or slickline logging operations, including before the wellbore 150 is completed. Moreover, components may be added to or removed from the VSP system 100 without departing from the scope of the present disclosure.

With reference to FIG. 2A, wellbore 150 and the seismic sources 104 are deployed in an alternative VSP geometry that uses a walk above configuration. The wellbore 150 is not strictly vertical, but is deviated or even horizontal. Multiple seismic sources 104a-c are deployed at the surface 108 and multiple seismic receivers 102 a-c are deployed in the wellbore 150. The location of each seismic source 104a-c is selected to be directly above one of the receivers 102a-c. The location of seismic source 104a is selected to be directly above the seismic receiver 102a, the location of seismic source 104b is selected to be directly above the seismic receiver 102b, and the location of seismic source 104c is selected to be directly above the seismic receiver 102c. Using this configuration, a walk above VSP survey can mimic the geometry of a vertical well and a zero offset VSP by combining data collected by the seismic sources 104a-c.

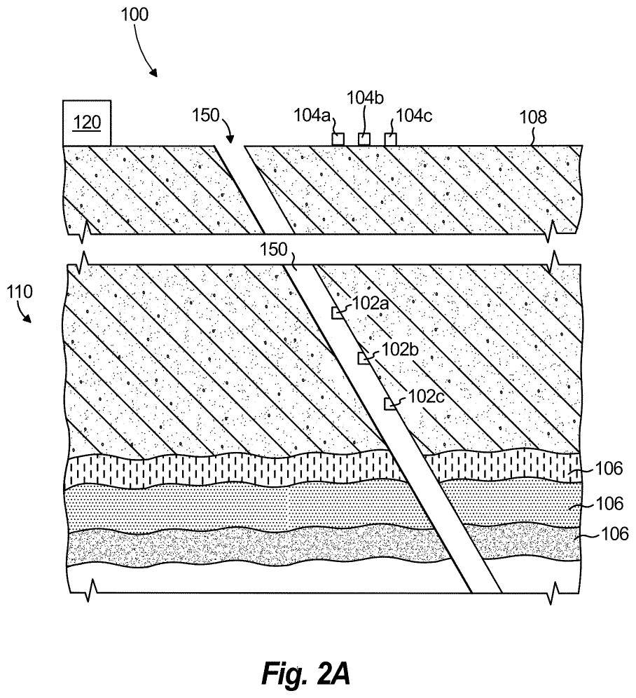

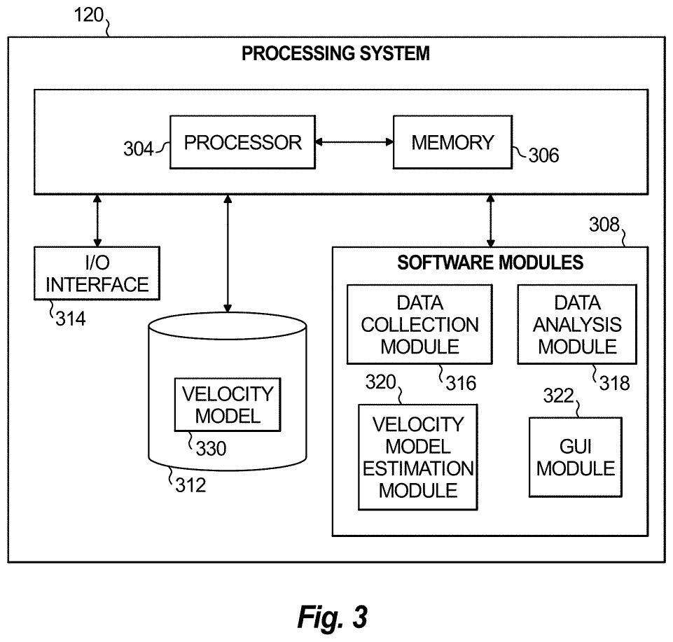

FIG. 3 illustrates a block diagram of an exemplary processing system 120, in accordance with embodiments of the present disclosure. The processing system 120 may be configured to receive VSP data from receivers (e.g., seismic receivers 102 shown in FIGS. 1 and 2), and analyze the VSP data, such as to perform one or more noise reduction methods, data quality evaluation methods, data migration methods, slant stack analysis, semblance construction methods, formation velocity estimation methods, and image display methods. A portion of the processing system 120 can perform processing for VSP data collected by different drilling and logging systems, even when such drilling and logging systems are positioned at different locations.

The processing system 120 includes at least one processor 304. Processor 304 may include, for example a microprocessor, microcontroller, digital signal processor (DSP), application specific integrated circuit (ASIC), or any other digital or analog circuitry configured to interpret and/or execute program instructions and/or process data. As depicted, the processor 304 is communicatively coupled to at least one memory 306 and configured to interpret and/or execute program instructions stored in memory 306, and/or read and/or write data stored in memory 306. The program instructions may be included in one or more software modules 308, such as data collection module 316, data analysis module 318, velocity model estimation module 320, and GUI module 322.

Memory 306 may include any system, device, or apparatus configured to hold and/or house one or more memory modules; for example, memory 306 may include read-only memory, random access memory, solid state memory, or disk-based memory. Each memory module may include any system, device or apparatus configured to retain program instructions and/or data for a period of time (e.g., computer-readable non-transitory media). For example, instructions from the software modules 316, 318, 320, and 322 may be retrieved and stored in memory 306 for execution by processor 304.

In an embodiment of the present disclosure, data used or generated by the software modules 316, 318, 320, and 322, e.g., VSP data received from receivers 102, results of analysis of the VSP data, as well as one or more velocity models 330, etc., may be stored in database 312 for temporary or long-term storage. In certain embodiments, the processing system 120 may further include one or more displays or other input/output peripherals such that information processed by the processing system 120 can be displayed, such as graphical displays of the VSP data and semblances.

Processing system 120 can further include at least one communication port 314 to enable communication with external devices, e.g., networked devices or peripheral devices (e.g., input and output (“I/O”) devices, such as a keyboard, a mouse, and a video display). The processing system 120 can include a plurality of individual processing systems, e.g., that are networked to one another.

In embodiments, the processing system 120 can include different sub-processing systems that execute the data collection module 316 for collecting VSP data output by the receivers, the data analysis module 318, the velocity model estimation module 320, and the GUI module 322. The different sub-processing systems may be communicably coupled to at least another one of the sub-processing systems, through, for instance, a wired or wireless communication link. For example, a sub-processing system executing the data collection module 316 can be positioned at the surface 108 of the subterranean formation 110 proximate the wellbore 150, whereas one or more sub-processing systems executing the data analysis module 318, the velocity model estimation module 320, and the GUI module 322 can be located at one or more location that is remote from the wellbore 150. Two or more of the sub-processing systems can share components, e.g., processor 304, memory 306, database 312, and/or communication port 314, or include their own individual components.

In embodiments, the data received by the data collection module 316 can be simulated VSP data, which can be received, for example, from a simulator, external data center, or storage server that stores a library of VSP data.

Modifications, additions, or omissions may be made to FIG. 3 without departing from the scope of the present disclosure. For example, FIG. 3 shows a configuration of components of processing m system 120. However, any suitable configurations of components may be used. For example, components of processing system 120 may be implemented either as physical or logical components. Furthermore, in some embodiments, functionality associated with components of processing system 120 may be implemented in special purpose circuits or components. In other embodiments, functionality associated with components of processing system 120 may be implemented in configurable general purpose circuits or components. For example, components of processing system 120 may be implemented by configured computer program instructions.

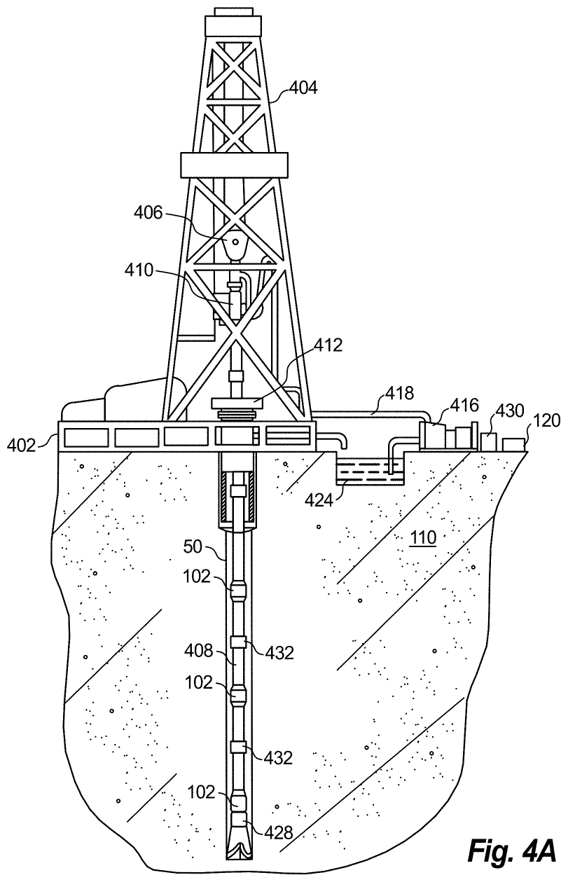

With reference to FIGS. 4A and 4B, examples of oil well drilling equipment and drilling environments with which the VSP system disclosed can be used are shown. FIG. 4A shows a suitable context for describing the operation of the disclosed systems and methods in an illustrated logging while drilling (LWD) environment. A drilling platform 402 is equipped with a derrick 404 that supports a hoist 406 for raising and lowering a drill string 408. The hoist 406 suspends a top drive 410 that rotates the drill string 408 as it is lowered through a well head 412. Connected to the lower end of the drill string 408 may be a drill bit (not shown) that rotates, such as to create the wellbore 150 that passes through the formation 110. A bottomhole assembly (BHA) (not shown) may be provided near the drill bit to collect data.

A pump 416 circulates drilling fluid through a supply pipe 418 to top drive 410, through the interior of drill string 408, through orifices in the drill bit, back to the surface, and into a retention pit 424. The drilling fluid transports cuttings from the wellbore 150 into the pit 424 and aids in maintaining the integrity of the wellbore 150. Drilling fluid, often referred to in the industry as “mud,” is often categorized as either water-based or oil-based, depending on the solvent.

Data from the seismic receivers 102 can be transmitted using various forms of telemetry used in drilling operations. Seismic receivers 102 can be coupled to a telemetry module 428 that can transmit telemetry signals. These telemetry signals can be transmitted to a receiving device 430 at the surface 108 of wellbore 150. The receiving device 430 can be incorporated in or in communication with the processing system 120 to provide the telemetry signals to the processing system 120. The transmission of the telemetry signals can be performed by one or more devices, such as a downhole receiver that receives the telemetry signals output by the telemetry module 428 and/or downhole repeaters that receive and retransmit the telemetry signals until they can be received by the receiving device 430 at the surface 108 of the wellbore 150.

For example, the telemetry module 428 can include an acoustic telemetry transmitter that transmits telemetry signals in the form of acoustic vibrations in the tubing wall of drill string 408. The downhole receiver can be coupled to tubing below the top drive 410 to receive transmitted telemetry signals. The downhole repeaters can include one or more repeater modules 432 that can be optionally provided along the drill string 408 to receive and retransmit the telemetry signals. Other telemetry techniques can be employed, including mud pulse telemetry, electromagnetic telemetry, and wired drill pipe telemetry. In some embodiments, the telemetry module 428 also or alternatively stores VSP data output by the seismic receivers 102 for later retrieval when the telemetry module 428 is returned to the surface 108 of the wellbore 150.

FIG. 4B shows another suitable context for describing the operation of the disclosed systems and methods in which a wireline configuration is used. Logging operations can then be conducted using a wireline logging tool 450, e.g., a sonde sensing instrument, suspended by a cable 456. The cable 456 can include conductors for transporting power to the tool 450 and/or communications from the tool 450 to the surface of the wellbore 150. A logging portion of the wireline logging tool 450 may have centralizing arms 452 that center the tool 450 within the wellbore 150 as the tool 450 is pulled uphole. In certain embodiments, the seismic receivers 102 can be mounted to cable 456 and lowered into the wellbore 150. In other embodiments, the receivers 102 can be channels from a DAS fiber optic recording system.

As in the LWD environment shown in FIG. 4A, telemetry can be used to provide data output by the seismic receivers 102 to the processing system 120. The seismic receivers 102 can be coupled to telemetry module 428, so that telemetry signals can be transmitted from the seismic receivers 102 via one or more repeater modules 432 and/or a downhole receiver (not shown) to the receiving device 430 at the surface 108 of wellbore 150.

A logging facility 460 collects measurements from the wireline logging tool 450, and includes computing facilities 462 that can include receiving device 430 for receiving the telemetric signals and/or processing system 120 for processing and storing VSP data output by seismic receivers 102.

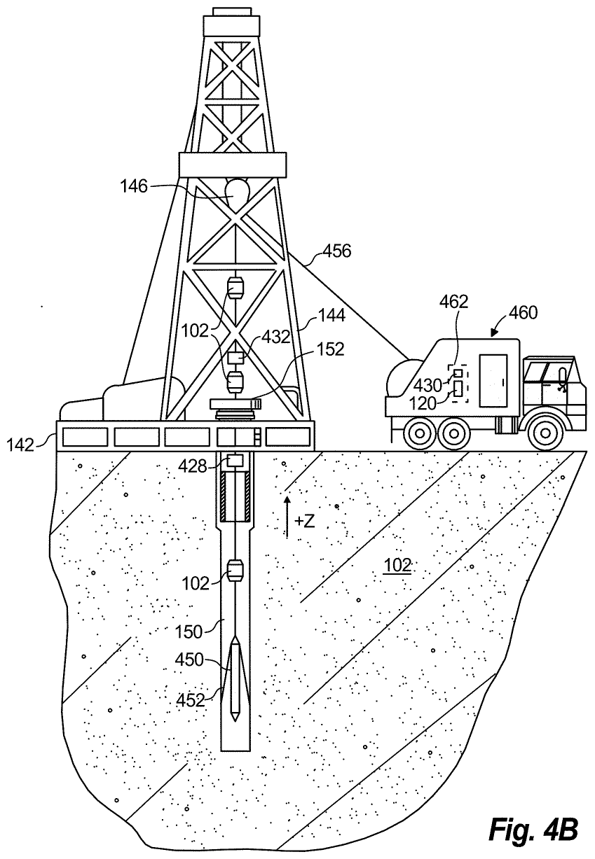

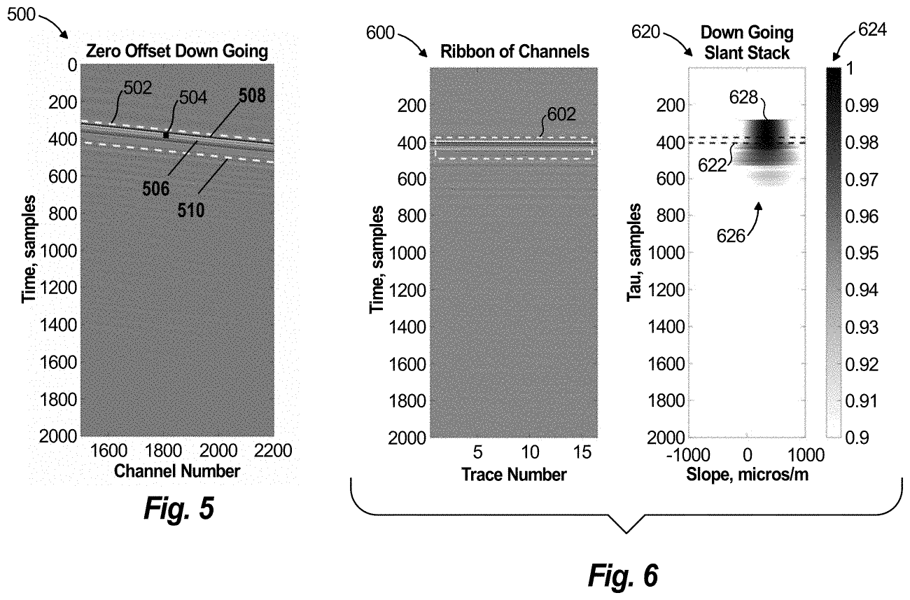

With reference to FIG. 5, plot 500 shows ZOVSP data that corresponds to a down-going wave field (also referred to as down-going ZOVSP data), obtained during VSP testing using zero (or nearly zero) offset and a VSP system (such as VSP system 100) deployed at a wellbore. The horizontal or x-axis of plot 500 represents channel numbers associated with different receivers (e.g., geophones or hydrophones) or channels along a DAS fiber optic receiver, and the vertical or y-axis represents samples that can be taken over time, such as at regular time intervals. White dotted line box 502 indicates a range of the ZOVSP data to be analyzed, such as by stack analysis described further below, wherein the range is based on arrival time picks.

Arrival time picks are arrival times selected from the ZOVSP data that correspond to the arrival of the first break picks. The first break picks correspond to the seismic receiver detecting a significant change in an ambient or threshold noise level. Arrival times can be obtained automatically or manually. In embodiments, the arrival times may be extracted using an algorithm, such as a first break threshold detection algorithm. However, when conditions are noisy, the time associated with the first break pick can be entered manually as a seed arrival time pick. Reference number 504 indicates an example of an arrival time pick that was detected automatically or entered manually. This arrival time pick 504 may be used as one of several seed arrival time picks and the dashed white lines 502 represent a range of data around the seed arrival time picks that may be used as part of the formation velocity estimation process.

The slope and placement of an arrival time line 506 is determined by interpolating multiple arrival time picks 504. This slope is referred to as a slope of arrival times. The arrival time line 506 can be extended in either direction. The box 502 is formed using a top line 508 and a bottom line 510 that track the slope of the arrival time line 506. In the example shown, the top line 508 is spaced slightly above arrive time line 506 and the bottom line 510 is spaced below the arrival time line 506, with the spacing between lines 510 and 506 being greater than the spacing between lines 508 and 506. The space between lines 508 and 510 provides a time window. This time window can be selected based on conditions, such as noise to signal ratio. When noise is minimal, a range can correspond to three cycles, and can be extended to a full record length, such as under noisy conditions.

In some embodiments, instead of a simple first break threshold detection algorithm, the arrival times may be determined using a semblance-based linear stacking method called slant stacking. The slant stacking involves a Radon transformation of the ZOVSP data and is performed over a sliding ribbon (also referred to as a window) of a range of channels. Each trace of a ribbon of traces includes the VSP data associated with each channel of a ribbon of channels. Semblance is a coherence statistic that provides a quantitative measure of the similarity of seismic data from multiple channels, and can be defined, for example, by Equation (1):

$$S ( τ , p ) = \frac{{Σ}_{t 1}^{t 2} ( {Σ}_{1}^{M} {{f}_{i} ( t + {δ}_{i} )}^{2} )}{M {Σ}_{t 1}^{t 2} ( {Σ}_{1}^{M} {f}_{i}^{2} ( t + {δ}_{i} ) )} \\ \qquad ( 1 )$$

where S is the semblance value, p is the slope value that indicates slope of arrival times for the ith trace of a ribbon of traces, t is time over a time window defined by the interval t1 to t2, fᵢ is the ith trace in the ribbon, M is the number of traces in the ribbon, and δ is the observed time lag (the time lag between the first trace in the ribbon and the current trace i) associated with the linear slope p for trace i, and τ is time lag associated with the time window t1 to t2. The value of r can be assigned to the time of the first sample of the time window of the first trace in the ribbon of traces, to the middle of the time window of the first trace in the ribbon of traces, or in another reasonable fashion to the time window of the ribbon of traces. τ varies from the top of the trace to the bottom of the trace, while the range of slopes analyzed is selected from a reasonable range of slownesses of the rock formation, for example from −1000 to 1000 microseconds/meter.

In other words, the semblance S, as a function of slope versus time lag associated with the time window, is determined based on a summation over the time window of arrival times for each trace of the ribbon of traces, wherein the arrival times account for time lag associated with the linear slope p for the trace.

FIG. 6 shows two plots 600 and 620 illustrating the ZOVSP data in FIG. 5 after further processing. Plot 600 shows the down-going ZOVSP data shown in FIG. 5, but for only sixteen channels (2000-2015), where the group of channels is referred to as a ribbon. Plot 600 includes a white dotted line box at a position of a sliding window 602 that (similar to box 502 in plot 500 of FIG. 5) indicates a range of interest around the arrival times associated with the first break pick of the ZOVSP data. Plot 620 represents a full slant stack analysis of plot 600. The vertical axis of plot 620 represents the time lag τ, and the horizontal axis represents the range of slopes p. Referring to Equation (1), the size of the time interval t1-t2 used can be selected to optimize quality of the input data. This selection can be done, for example, by sliding the sliding window 602 up or down to achieve an optimal high amplitude portion, indicated at 628. Semblance values S determined in accordance with Equation (1) are color coded using a gray scale 624, wherein the darker shades indicate higher amplitude and greater coherence. The semblance values S determined based on Equation (1) are plotted as semblance data, indicated at 626.

The area of interest for the analysis represented in plot 620 relates to the area shown in the white dotted line box at the position of the sliding window 602 that corresponds to the slope of the first break of the down-going ZOVSP data for the position of the sliding window 602, which corresponds to the time interval t1-t2 in Equation (1). The corresponding range of the slant stack analysis represented in plot 620 which is of interest is designated by black dotted line box 622. Thus, the slant stack analysis can be performed for the area of interest, rather than for all values of τ (time lags).

The black, high amplitude portion 628 of the plotted semblance data 626 plotted in plot 620 represents the best coherence associated with traces that correspond to the ribbon of channels represented in plot 600. The peak semblance value (which is shown as the blackest data plotted) of high amplitude portion 628 corresponds to a slope of approximately 400 micros/m, which indicates the best linear moveout across the ribbon of channels.

The slant stack analysis is repeated iteratively for each next ribbon of channels as the sliding window 602 is moved out by incrementing the first channel of the ribbon to the next channel and sliding the ribbon along the range of channels shown in plot 500 of FIG. 5. In the current example, the ribbon of channels used in the next iteration would include channels 2001-2016.

The amount of computations performed and data output by the slant stack analysis can be reduced by processing only down-going ZOVSP data that corresponds to a selected arrival window, such as the first arrival window used in this example. The first arrival window corresponds to a single set of values per ribbon of channels that correspond to a single value of τ, wherein τ is associated with the arrival time of the first break on the trace that corresponds to the first channel of the ribbon of channels. In embodiments, computations can be performed using a different arrival window from the first arrival window (e.g., second, third, fourth window, etc.).

In other words, since the slant stack analysis is mainly interested in the moveout, or slope, of the first break itself (shown by the dotted white box at the current position of the sliding window 602 in plot 600, and denoted by t1 to t2 in Equation (1)), the range of the slant stack analysis can be limited to only the black dotted line box 622 in FIG. 6. It is not necessary to run the entire analysis for all time lags τ, but rather only for a window around the event of interest. The black, high amplitude portion 628 in plot 620 shows the best coherence for the traces in plot 600 and thus the best linear moveout across the 16 traces near time sample 400. The sliding window 602 is then slid down the range of channels in plot 500 (FIG. 5), the next set of traces is selected (e.g., channels 2001-2016) and the slant stack analysis is repeated.

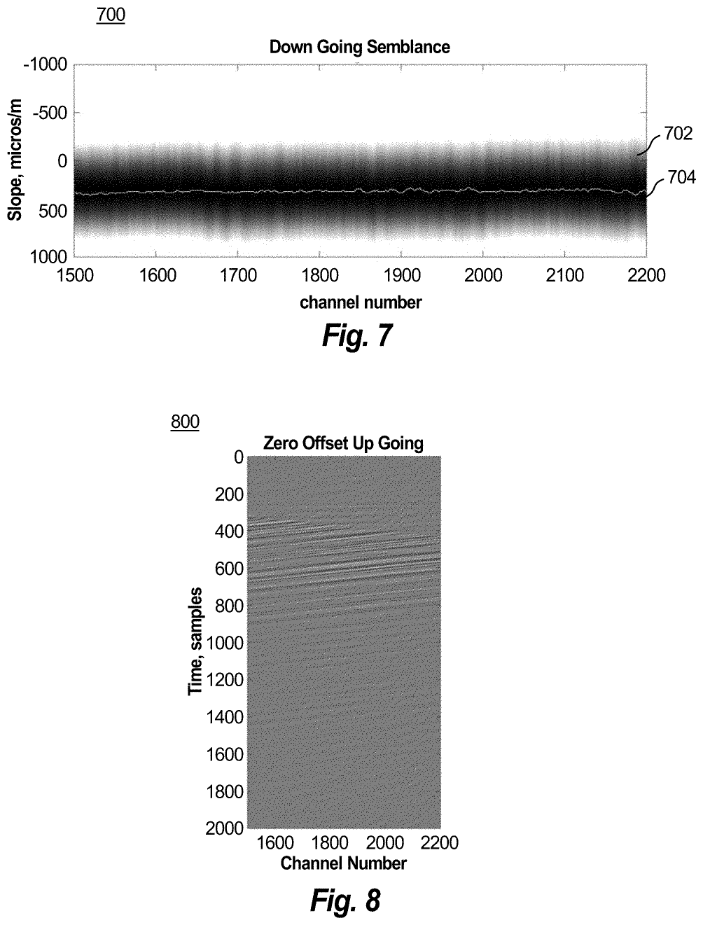

In addition, since only one set of coherence values needs to be obtained for the first arrival window, the slant stack analysis may be compressed to a single set of values per position of the sliding window 602, corresponding to a single value of τ representing the arrival time of the first break on the first trace in the sliding window 602. FIG. 7 shows the “compressed” slant stack analysis.

With reference to FIG. 7, a plot 700 is shown that represents semblance, indicated at 702, of the down-going ZOVSP data shown in plot 500 of FIG. 5. The semblance 702 was obtained by applying the slant stack analysis to only the first arrival window, thus reducing computations and amount of output data. Plot 700 is also referred to as a slant stack, linear moveout analysis of a sliding ribbon of traces of the down-going ZOVSP data. The vertical axis of plot 700 represents the slope (i.e., 1/velocity, also referred to as slowness). The horizontal axis of plot 700 represents channel number, e.g., for the full range of channel numbers shown in plot 500. It is understood that since there is a reciprocal relationship between velocity and slowness, a determination or estimation of either slowness or velocity indicates that the other of slowness or velocity has also been determined or estimated based on application of the reciprocal relationship.

The solid white line 704 represents the peak of the semblance 702 for each channel, wherein the peak is plotted for the first channel of each ribbon of channels. The semblance peaks represented by solid white line 704 are an estimate of the fit of the ZOVSP data to the slowness values associated with respective ribbons of traces of the sliding ribbons of traces being tested. Thus, the semblance peak values provide a measure of how well the slowness values fit the ZOVSP data included in the ribbons of traces being tested. A similar type of analysis may be performed for an up-going wave field, an exemplary data set for which is shown in FIG. 8.

FIG. 8 shows a plot 800 of ZOVSP data that corresponds to the up-going wave field (also referred to as up-going ZOVSP data) that can be analyzed using an analysis that is similar to the analysis applied to the down-going ZOVSP data. Similar to plot 500 in FIG. 5 of the down-going ZOVSP data, the x-axis of plot 800 represents channel numbers, and the y-axis represents samples taken over time.

In FIG. 8, arrival times of the up-going ZOVSP data can be determined using slant stacking that uses the linear stacking method defined by Equation (1), in which a sliding ribbon (also referred to as a window) that includes a sub-range of channels is slid incrementally across a range of channels. The slant stack analysis can be performed for an area of interest associated with a selected time range, similar to the white dotted line box at the position of the sliding window 602 (from FIG. 6). Note how the up-going ZOVSP data shown in plot 800 is noisier than the down-going ZOVSP data of plot 500 shown in FIG. 5.

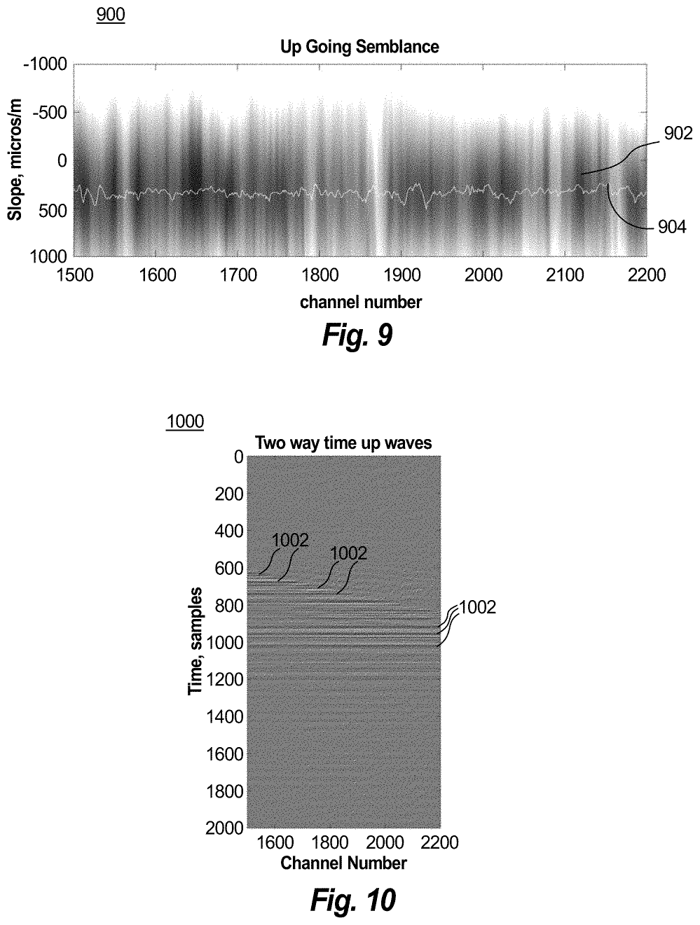

FIG. 9 shows a plot 900 of the slant stack analysis of the up-going ZOVSP data in FIG. 8 obtained by sliding a window incrementally across the range of channels shown along the x-axis. This analysis is also referred to as a slant stack, linear moveout analysis. Similar to plot 700 of FIG. 7, the vertical axis of plot 900 represents the slope (i.e., 1/velocity, also referred to as slowness), and the horizontal axis represents channel number, e.g., for the full range of channel numbers shown in plot 800. The semblance indicated at 902 represents the up-going ZOVSP data shown in plot 800 of FIG. 8 and was obtained by applying the slant stack analysis to only the first arrival window. The solid white line 904 scribes out the peak of the semblance for each channel, with the peak plotted for the first channel of each ribbon of channels. The semblance peaks represented by solid white line 904 are an estimate of the fit of the ZOVSP data shown in FIG. 8 to the slowness values associated with respective ribbons of traces of the sliding ribbons of traces being tested. Thus, the semblance peak values provide a measure of how well the slowness values (slope) fit the ZOVSP data included in the ribbons of traces being tested. Note how the picks of the peak semblance scribed by white line 904 are noisier than the corresponding values for the down-going ZOVSP data shown in FIG. 7.

Referring to FIG. 10, another way to use the down-going wave field is by using the first breaks picked on the down-going wave field to transform the up-going wave field to two way time. FIG. 10 shows a plot 1000 of several up-going wave fields or reflection events 1002 derived from the down-going ZOVSP data. The reflection events 1002 were obtained by using the first breaks picked from the down-going ZOVSP data to transform (e.g., by adding) the up-going ZOVSP data to two-way time (i.e., roundtrip time from/to the surface). These reflection events 1002 in plot 1000 represent the up-going ZOVSP data after it has been time shifted downward by the exact amount as the first break times estimated from the down-going ZOVSP data. After the up-going ZOVSP data has been transformed to two-way time, the slant stack analysis can be performed to find residual time shifts which align the reflection events 1002.

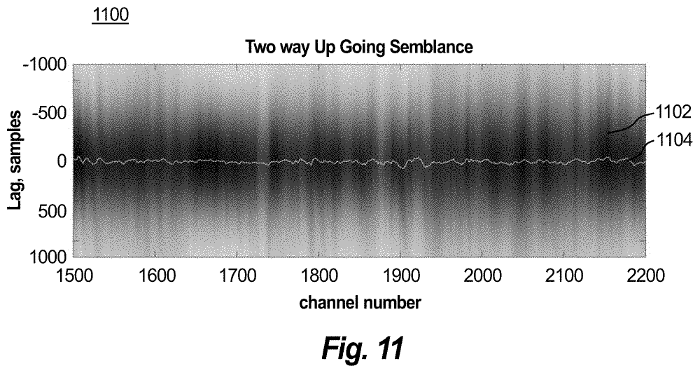

FIG. 11 shows a plot 1100 of the slant stack analysis of the two-way time up-going wave field obtained by sliding a window incrementally across the range of channels shown along the x-axis of FIG. 10. Semblance is indicated at 1102 and results from a slant stack, linear moveout analysis of the sliding window of traces of the up-going ZOVSP data. Similar to plot 700 of FIG. 7, the vertical axis of plot 1100 represents the slope (i.e., 1/velocity, also referred to as slowness), and the horizontal axis represents channel number, e.g., for the full range of channel numbers shown in plot 1000 of FIG. 10. Semblance 1102 represents the two-way time up-going ZOVSP data shown in plot 1000 of FIG. 10 obtained by applying the slant stack analysis to only the first arrival window. The solid white line 1104 scribes out the peak of the semblance for each channel, with the peak plotted for the first channel of each ribbon of channels. The semblance peaks represented by white line 1104 are an estimate of the fit of the ZOVSP data shown in FIG. 10 to the slowness values associated with ribbons of traces of the sliding ribbons of traces being tested. Thus, the semblance peak values provide a measure of how well the slowness values (slope) fit the ZOVSP data included in the ribbons of traces being tested.

In FIG. 10, the jitter or variation in the peak picks represented by solid white line 1104 has been reduced significantly due to the alignment of the reflection events 1002 (i.e., when the up-going ZOVSP data was transformed to two-way time using the down-going first break picks). Each of the aligned reflection events of plot 1000 in FIG. 10 can be used to extract an estimate of the residual time shifts. There are approximately ten or more events 1002 clearly visible in plot 1000 that could be used independently to obtain estimates of the residual time shifts.

The formation velocity (or slowness) for each channel can then be derived using an inversion algorithm or procedure that uses any of the slowness estimates shown above. Smoothing and/or filtering can optionally be applied to the slowness estimation values associated with the down-going portion and up-going portions of the VSP data before application of the inversion algorithm. For example, the slowness estimates in FIG. 7 that use the peak semblance values associated with the first break picks of the down-going ZOVSP data may be used jointly with the slowness estimates shown in FIG. 9 that use the peak semblance values associated with the first break picks of the up-going ZOVSP data. Or the inversion algorithm or procedure may use the peak semblance values in FIG. 7 with the peak semblance values associated with the residual picks of the up-going ZOVSP data from FIG. 11. In addition, the formation velocity can be derived using additional slowness estimates that are based on different selectable time windows of the two-way time converted up-going wave field shown in FIG. 11. Thus, two or more data sets may be used as input to the inversion algorithm or procedure.

Most inversion algorithms or procedures are based on the well-known inverse problem. Traditionally, the inverse problem is formulated as shown in Equation (2):

G*m=d, (2)

where G is a forward response of the earth based upon the acquisition geometry, m is a vector of model parameters to be estimated, and d is observed data. The conventional solution to this inverse problem is given by Equation (3):

m=(G^{T}G)⁻¹G^{T}d (3)

However, a solution according to the disclosed embodiments uses a more sophisticated inversion approach than is provided by Equation (3). Referring to Equation (4), shown below, the inversion approach disclosed herein uses multiple sets of observed data associated with the down-going and up-going ZOVSP data that are provided as input and processed for matching with synthetically predicted data:

$$\frac{1}{M} [ \begin{matrix}1 & 1 & 1 & 1 & 1 & 1 & 0 & 0 & & & & & • & • & • & • & & & 0 \\ 0 & 1 & 1 & 1 & 1 & 1 & 1 & 0 & 0 & & & & • & • & • & • & & & 0 \\ 0 & 1 & 1 & 1 & 1 & 1 & 1 & 1 & 0 & 0 & & & • & • & • & • & & & 0 \\ • & & & & & & & & & & & & & & & & & & • \\ • & & & & & & & & & & & & & & & & & & • \\ • & & & & & & & & & & & & & & & & & & • \\ • & & & & & & & & & & & & & & & & & & • \\ 0 & & & • & • & • & • & & & & 0 & 0 & 0 & 1 & 1 & 1 & 1 & 1 & 1\end{matrix} ] \cdot \\ [ \begin{matrix}{S}_{1} \\ {S}_{2} \\ {S}_{3} \\ • \\ • \\ • \\ • \\ {S}_{n}\end{matrix} ] = [ \begin{matrix}Δ {t}_{1} / D Z \\ Δ {t}_{2} / D Z \\ Δ {t}_{3} / D Z \\ • \\ • \\ • \\ • \\ Δ {t}_{n} / D Z\end{matrix} ] \\ G * m = d , \qquad ( 4 )$$

where G is a forward modeling operator (also referred to as the G matrix), m is a current estimated model parameter vector (also referred to as the m vector), and d is predicted (synthetic) data (also referred to as the d vector). The m vector includes the slowness values of each layer in the model. The d vector includes the slope values which are being predicted to match the slope (which represents slowness) derived from the input data, where Δt is the time lag indicating the moveout of the event across the ribbon of channels and DZ is the distance corresponding to M traces in the ribbon. The number of ones, 1's, in each row of the matrix G corresponds to the number of traces, M, in the ribbon. The placement of the ones in the matrix G corresponds to the channel range used in each ribbon. In the example shown for Equation (4), six traces are included per ribbon for the sake of simplicity; however, the number of traces included per ribbon is not limited by this example. In the current example, M=6, and the G matrix is multiplied by ⅙.

Each set of data that corresponds to one of the picks of the down-going ZOVSP data or the picks of the up-going ZOVSP data can be processed using Equation (4). As the equation shows, the proposed inversion scheme uses two or more sets of input data for estimating interval slownesses (or velocities), which provides a greater degree of confidence than methods that use one set of input data, e.g., only input data related to down-going ZOVSP data. A first data set of the two or more sets of input data includes slopes (slownesses) between receivers or channels for direct down-going P wave arrivals (the down-going ZOVSP data), and a second data set (or additional data sets) includes slopes obtained from the analysis of the up-going P wave reflected energy within the same arrangement of receivers or channels, as in the case of direct P wave arrivals (the up-going ZOVSP data).

These multiple data sets of input data can be inverted jointly to obtain a common set of inverted parameters using, for example, a scheme minimizing a weighted error function with a gradient based optimizer, or by casting the inversion as a multi-objective optimization problem.

In an embodiment that uses the scheme minimizing a weighted error function, minimizing a weighted error function can produce a single inversion solution that would be biased by the choice of weight used to combine the errors from both data sets.

On the other hand, in an embodiment that uses the multi-objective optimization problem, solutions can be found that simultaneously minimize both errors in the two or more input data sets associated with the down-going ZOVSP data and up-going ZOVSP data, while satisfying certain constraints on the model, for example the interval slowness model, as supported by Deb, K., Multi-Objective Optimization Using Evolutionary Algorithms: John Wiley and Sons, Inc, Chapter 2, 2001; and Padhi, A., et. al., Multicomponent Pre-Stack Seismic Waveform Inversion in Transversely Isotropic Media Using a Non-Dominated Sorting Genetic Algorithm, Geophys. J. Int., 196, 1600-1618, 2014. For example, a slope (slowness) data set associated with the down-going ZOVSP data may be denoted as d1=[ddn_1, ddn_2, . . . , ddn_n] and a slope (slowness) dataset associated with up-going ZOVSP data may be denoted as d2=[dup_1, dup_2, . . . , dup_n]. Accordingly, the error or misfit functions can be defined using Equations (5) and (6):

$$\begin{matrix}{y}_{d n}^{2} = {\sum }_{i = 1}^{n} {( ddn\_i - s\_dn \_i )}^{2} & ( 5 ) \\ {y}_{up}^{2} = {\sum }_{i = 1}^{n} {( dup\_i - s\_up \_i )}^{2} & ( 6 )\end{matrix}$$

where s_dn and s_up are synthetic arrival time slopes generated by an interval slowness model being evaluated for its fitness. Application of such an inversion scheme produces a set of solutions called Pareto-optimal solutions that minimize the error determined by Equations (5) and (6). If these solutions are plotted with axes defined by the functions described in Equations (5) and (6) being the two misfits, then the Pareto-optimal solutions would form a front with a convex shape when seen from the origin of the coordinate system used. Accordingly, these solutions are non-dominating, and a further choice of an inversion solution or optimal interval slowness model from this suite of solutions can depend on additional understanding of the geological constraints which may be qualitative in nature.

Multi-objective optimization problems can be solved using a variety of available algorithms. Example solutions are provided by Deb, K., et. al., A Fast and Elitist Multi-Objective Genetic Algorithm: NSGA-II, IEEE Transaction on Evolutionary Computation, 6, No. 2, 181-197, 2002; and Padhi, A., et. al, 2014. The example solutions use a non-dominated sorting genetic algorithm, NSGA II. The example algorithm starts with a random parent population of size N. This parent population undergoes steps, such as crossover, mutation and tournament selection, to produce a child population of size N. The combined population of size 2N can then be sorted into different ranks according to levels of non-dominance. For example, rank 1 members, wherein rank 1 is the highest rank, are better than all other solutions, but are not better than each other in terms of all the misfits. Rank 2 members are better than all other ranks except for rank 1 members, while being non-dominating among themselves. Next, members from various ranks, beginning with rank 1, are selected to form a next generation of N members. This process is continued until a stopping criterion is satisfied. In order to obtain a uniformly spread-out Pareto-optimal front during the tournament selection stage, NSGA II prefers a population member which is less crowded when choosing between two members that belong to the same rank.

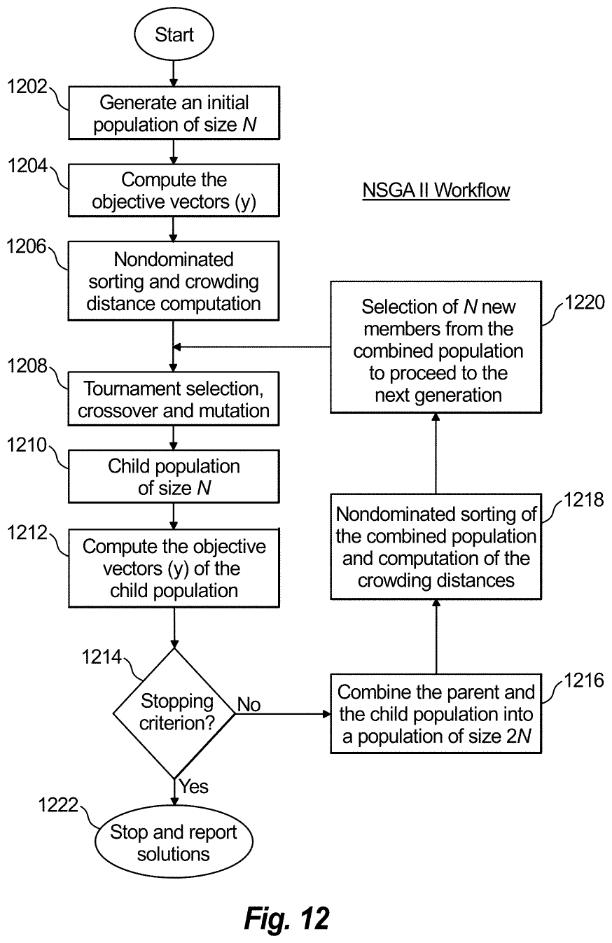

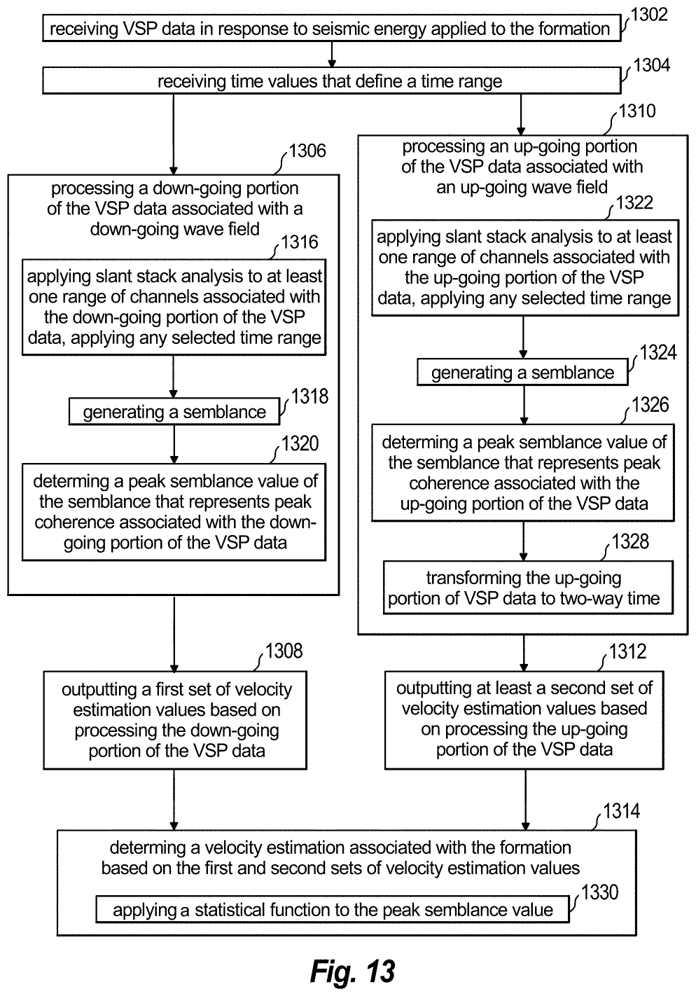

FIGS. 12 and 13 show flowcharts that demonstrate implementation of an exemplary embodiment of a method of the disclosure. It is noted that the order of operations shown in FIGS. 12 and 13 are not required, so in principle, the various operations may be performed out of the illustrated order and/or in parallel with one another. Also certain operations may be skipped, different operations may be added or substituted, or selected operations or groups of operations may be performed in a separate application following the embodiments described herein. The operations shown in FIGS. 12 and 13 can be performed by the processing system 120 shown in FIGS. 2, 3, 4A, and 4B. In particular, the processing system 120 may execute one or more of the software modules 308, causing the processing system 120 to perform the operations shown in the flowchart and described in the disclosure.

With reference now to FIG. 12, shown is a flowchart that demonstrates an example work flow for the NSGA II algorithm. At operation 1202, an initial population size N is generated. At operation 1204 objective vectors (y) are computed. At operation 1206, nondominated sorting and crowding distance is computed. At operation 1208, tournament selection is performed, such as based on crossover and mutation or crowding. At operation 1210, a child population size of N is determined. At operation 1212 objective vectors (y) of the child population are computed. At operation 1214, a determination is made whether a stopping criterion has been satisfied. If the determination at operation 1214 is No, meaning the stopping criterion has not been satisfied, then at operation 1216 the parent and the child population are combined into a population of size 2N. At operation 1218, nondominated sorting is performed for the combined population and crowding distances are computed. At operation 1220, N new members from the combined population are selected to proceed to the next generation, after which the method continues at operation 1208. If the determination at operation 1214 is Yes, meaning the stopping criterion has been satisfied, then at operation 1222 the method stops and solutions determined are reported.

With reference now to FIG. 13, shown is a flowchart that depicts a method performed by a processing system, such as the processing system 120 of FIG. 1. At operation 1302, VSP data is received in response to seismic energy applied to the formation. For example, the VSP data can be received from or by a data collection module, such as the data collection module 316 of FIG. 3. The VSP data can be near zero offset VSP data. The method shown in the flowchart can be included in a method performed by a VSP system, such as the VSP system 100 shown in FIG. 1. Although not shown in FIG. 13, the method performed by the VSP system can include applying the seismic energy with a seismic energy source, receiving the VSP data by receivers, and recording the received VSP data by a recording device that can be included with or in communication with the processing system.

At operation 1304, an optional operation, selected time values can be received that define a time range. The selected time values can be entered, for example, by an operator via a GUI module, such as the GUI module 322 shown in FIG. 3. Operations 1306 and 1310 can be performed by a data analysis module, for example, such as the data analysis module 318 shown in FIG. 3. Operations 1308, 1312, and 1314 can be performed by a slowness (or velocity) model estimation module 320 shown in FIG. 3.

At operation 1306, a down-going portion of the VSP data that is associated with a down-going wave field is processed. At operation 1308, a first set of slowness estimation values based on processing of the down-going portion of the VSP data is output. Optionally, operation 1308 can further include smoothing and/or filtering the slowness estimation values associated with the down-going portion of the VSP data before performing further processing on this data. At operation 1310, an up-going portion of the VSP data that is associated with an up-going wave field is processed. At operation 1312, at least one second set of slowness estimation values based on processing the up-going portion of the VSP data is output. Optionally, operation 1312 can further include smoothing and/or filtering the slowness estimation values associated with the up-going portion of the VSP data before performing further processing on this data. At operation 1314, a slowness estimation associated with the formation is determined based on the first set and the at least one second set of slowness estimation values. Accordingly, the slowness (or velocity) estimation is determined using down-going and up-going ZOVSP data.

Operation 1306 can include one or more of the operations 1316, 1318, and 1320. At operation 1316, slant stack analysis is applied to the down-going portion of the VSP data associated with a range of channels. The down-going portion of the VSP data can be associated with a sliding ribbon of traces associated with the range of channels. The slant stack analysis can be applied to a time range that includes arrival time picks of the first break, or to the time range defined by the received time values, wherein the time values can be selected so that the time range includes arrival time picks of breaks different than the first break. At operation 1318, a semblance is generated. The semblance represents a coherence statistic associated with the down-going VSP data.

The semblance can be generated by transforming traces associated with respective subranges of the range of channels from record space as a function of receiver offset versus sensed arrival time into a domain of ray parameter as a function of slope, p, versus intercept time, tau, determined. Transforming the traces can include summing arrival times associated with respective subranges of the range of channels.

At operation 1320, a peak value of the semblance is determined that represents peak coherence associated with the down-going portions of the VSP data. The respective peak semblance values represent an estimation of the fit of the down-going portions of VSP data associated with the respective subranges of the range of channels being tested, providing a measure of how well the slope of the respective subranges of the range of channels fits the VSP data included in the corresponding ribbon of traces that is associated with the respective subranges of the range of channels.

Operation 1310 can include one or more of the operations 1322, 1324, 1326, and 1328. At operation 1322, the up-going portion of the VSP data can optionally be transformed to two-way time. At operation 1324, slant stack analysis is applied to the up-going portion of the VSP data a range of channels. The up-going portion of the VSP data can be associated with a sliding ribbon of traces associated with the range of channels. If the up-going portion of the VSP data is transformed to two-way time at operation 1322, then the slant stack analysis is applied using the transformed up-going VSP data. The slant stack analysis can be applied to a time range that includes arrival time picks of the first break, or to the time range defined by the received time values, wherein the time values can be selected so that the time range includes arrival time picks of breaks different than the first break.

At operation 1326, a semblance is generated, wherein the semblance represents a coherence statistic related to the up-gong VSP data. At operation 1328, a peak value of the semblance is determined, wherein the peak semblance value represents an estimation of the fit of the up-going portions of VSP data associated with the respective subranges of the range of channels being tested. Thus, the peak semblance value, provides a measure of how well the slope of the respective subranges of the range of channels fits the VSP data included in the corresponding ribbon of traces that is associated with the respective subranges of the range of channels.

Operation 1314 can include operation 1330. At operation 1330, the velocity estimation associated with the formation could be determined by applying a statistical function to the slowness values associated with the peak semblance value, such as by averaging the slowness values or obtaining a mean of the values, and the like. However, the slowness estimation associated with the formation can alternatively be determined by applying an inversion process to the slowness values derived from the peak semblance values associated with the up-going portion of the VSP data and the slowness values derived from the peak semblance values associated with the down-going portion of the VSP data. The inversion process can include solving a multi-objective optimization problem. The multi-objective optimization problem can be solved using a nondominated sorting genetic algorithm.

Accordingly, the disclosed system and methods provide the ability to estimate slownesses or velocities associated with a formation. A method includes receiving VSP data in response to seismic energy applied to the formation, processing a down-going portion of the VSP data associated with a down-going wave field, outputting a first set of estimation values based on processing the down-going portion of the VSP data, the first set of estimation values estimating at least one of slowness or velocity, processing an up-going portion of the VSP data associated with an up-going wave field, outputting a second set of estimation values based on processing the up-going portion of the VSP data, the second set of estimation values estimating at least one of slowness or velocity, and determining an estimation of at least one velocity and slowness associated with the formation based on the first and second sets of estimation values.

In embodiments, processing the down-going portion of the VSP data can include applying slant stack analysis to the down-going portion of the VSP data associated with a range of channels. In embodiments, processing the up-going portion of the VSP data can include applying slant stack analysis to the up-going portion of the VSP data associated with a range of channels.

Additionally, in embodiments, applying the slant stack analysis to at least one of the down-going portion of the VSP data and the up-going portion of the VSP data associated with the range of channels can include generating a semblance as a function of slope and time lag of a plurality of ribbons of traces. Each ribbon of traces includes VSP data associated with a respective ribbon of channels incrementally slid along the range of channels, wherein the slope of one of the ribbon of traces is a slope of arrival times for each trace of the ribbon of traces and, the time lag of the ribbon of traces is an arrival time at a first channel in the ribbon of channels. The semblance can be determined based on a summation of the arrival times over the time window for each trace of the ribbon of traces, the arrival times accounting for time lag associated with the slope of the trace of ribbons.

In embodiments, the method further includes determining a peak semblance value of the semblance. The peak semblance value represents peak coherence associated with each of the up-going and down-going portions of the VSP data, and further represents a measure of how well the slope of the ribbon of traces fits the VSP data included in the ribbon of traces. In embodiments, determining the estimation of at least one of velocity and slowness associated with the formation can include applying a statistical function based on the peak semblance value associated with the up-going portion of the VSP data and the peak semblance value associated with the down-going portion of the VSP data. In other embodiments, determining the estimation of at least one velocity and slowness associated with the formation can include applying an inversion process to the slownesses corresponding to the peak semblance values associated with the up-going portion of the VSP data and the slownesses corresponding to the peak semblance values associated with the down-going portion of the VSP data. In embodiments, applying the inversion process can include solving a multi-objective optimization problem.

In addition, in embodiments, solving the multi-objective optimization problem can include using a nondominated sorting genetic algorithm. In embodiments, at least one of the down-going and up-going portions of VSP data that is processed can be associated with a time included in a time range that surrounds arrival time picks of a first break by a predetermined time threshold. Further, in embodiments, the method can further include receiving times that define a time range, wherein the time range includes arrival time picks of a break different than the first break, and at least one of the down-going and up-going portions of the VSP data that is processed includes VSP data associated with the break defined by the time range. Additionally, in embodiments, the up-going portion of VSP data can be transformed to two-way time. In embodiments, the VSP data can be included in near zero offset VSP data. In embodiments, the method can further include applying the seismic energy and recording the VSP data.

A VSP system is provided that includes at least one seismic energy source applying seismic energy to a formation undergoing a VSP survey, at least one receiver defining a plurality of channels disposed below a surface of the formation to output VSP data in response to detecting seismic energy associated with the applied seismic energy, and a processing system. The processing system includes at least one processor and a memory coupled to the processor. The memory stores programmable instructions, that when executed by the processor, cause the processor to receive vertical seismic profiling (VSP) data in response to seismic energy applied to the formation, process a down-going portion of the VSP data associated with a down-going wave field, output a first set of estimation values based on processing the down-going portion of the VSP data, the first set of estimation values estimating at least one of slowness or velocity, process an up-going portion of the VSP data associated with an up-going wave field, output a second set of estimation values based on processing the up-going portion of the VSP data, the second set of estimation values estimating at least one of slowness or velocity, and determine an estimation of at least one velocity and slowness associated with the formation based on the first and second sets of velocity estimation values.

In embodiments, processing at least one of the down-going portion of the VSP data and the up-going portion of the VSP data can include applying slant stack analysis to VSP data associated with the range of channels associated with each of the corresponding down-going and up-going portion of the VSP data.

In embodiments, applying the slant stack analysis to at least one of down-going portion of the VSP data and the up-going portion of the VSP data associated with the range of channels can include generating a semblance. Generating the semblance can include transforming traces associated with respective ranges of the range of channels from record space as a function of receiver offset versus sensed arrival time into a domain of ray parameter as a function of slope, p, versus intercept time lag, tau, of a plurality of ribbons of traces. Each ribbon of traces can include VSP data associated with a respective ribbon of channels incrementally slid along the range of channels, wherein the slope of one of the ribbon of traces is a slope of arrival times for each trace of the ribbon of traces and the time lag of the ribbon of traces is an arrival time at a first channel in the ribbon of channels.

In embodiments, the programmable instructions, when executed by the processor, further cause the processor to determine a peak semblance value of the semblance, the peak semblance value representing peak coherence associated with each of the up-going and down-going portions of the VSP data that represents a measure of how well the slope of the ribbon of traces fits the VSP data included in the ribbon of traces.

A computer system includes a processor and a memory coupled to the processor, wherein the memory stores programmable instructions. When the processor executes the programmable instructions, the processor is caused to receive vertical seismic profiling (VSP) data in response to seismic energy applied to the formation, process a down-going portion of the VSP data associated with a down-going wave field, output a first set of estimation values based on processing the down-going portion of the VSP data, the first set of estimation values estimating at least one of slowness or velocity, process an up-going portion of the VSP data associated with an up-going wave field, output a second set of estimation values based on processing the up-going portion of the VSP data, the second set of estimation values estimating at least one of slowness or velocity, and determine an estimation of at least one velocity and slowness associated with the formation based on the first and second sets of velocity estimation values.

In embodiments, processing at least one of the down-going portion of the VSP data and the up-going portion of the VSP data can include applying slant stack analysis to VSP data associated with the range of channels associated with each of the corresponding down-going and up-going portion of the VSP data.

While particular aspects, implementations, and applications of the present disclosure have been illustrated and described, it is to be understood that the present disclosure is not limited to the precise construction and compositions disclosed herein and that various modifications, changes, and variations may be apparent from the foregoing descriptions without departing from the spirit and scope of the disclosed embodiments as defined in the appended claims.

1. A method for estimating formation velocities associated with a formation, the method comprising:
receiving vertical seismic profiling (VSP) data in response to seismic energy applied to the formation;
processing a down-going portion of the VSP data associated with a down-going wave field;
outputting a first set of estimation values based on processing the down-going portion of the VSP data, the first set of estimation values estimating at least one of slowness or velocity;
processing an up-going portion of the VSP data associated with an up-going wave field;
outputting a second set of estimation values based on processing the up-going portion of the VSP data; and
determining an estimation of at least one of slowness or velocity associated with the formation based on the first and second sets of estimation values.

2. The method of claim 1, wherein processing the down-going portion of the VSP data comprises applying slant stack analysis to the down-going portion of the VSP data associated with a range of channels.

3. The method of claim 2, wherein processing the up-going portion of the VSP data comprises applying slant stack analysis to the up-going portion of the VSP data associated with the range of channels.

4. The method of claim 3, wherein applying the slant stack analysis to at least one of the down-going portion of the VSP data and the up-going portion of the VSP data associated with the range of channels includes generating a semblance as a function of slope and time lag of a plurality of ribbons of traces, each ribbon of traces including VSP data associated with a respective ribbon of channels incrementally slid along the range of channels, the slope of one of the ribbon of traces being a slope of arrival times for each trace of the ribbon of traces and the time lag of the ribbon of traces being an arrival time at a first channel in the ribbon of channels,
wherein the semblance is determined based on a summation of the arrival times over the time window for each trace of the ribbon of traces, the arrival times accounting for time lag associated with the slope of the trace of ribbons.

5. The method of claim 4, further comprising determining a peak semblance value of the semblance, the peak semblance value representing peak coherence associated with each of the up-going and down-going portions of the VSP data that represents a measure of how well the slope of the ribbon of traces fits the VSP data included in the ribbon of traces.

6. The method of claim 5, wherein determining the estimation of at least one velocity and slowness associated with the formation includes applying a statistical function based on the peak semblance value associated with the up-going portion of the VSP data and the peak semblance value associated with the down-going portion of the VSP data.

7. The method of claim 5, wherein determining the estimation of at least one velocity and slowness associated with the formation includes applying an inversion process to the peak semblance value associated with the up-going portion of the VSP data and the peak semblance value associated with the down-going portion of the VSP data.

8. The method of claim 7, wherein applying the inversion process includes solving a multi-objective optimization problem.

9. The method of claim 8, wherein solving the multi-objective optimization problem includes using a nondominated sorting genetic algorithm.

10. The method of claim 1, wherein at least one of the down-going and up-going portions of VSP data that is processed is associated with a time included in a time window that surrounds arrival time picks of a first break by a predetermined time threshold.

11. The method of claim 1, further comprising receiving times that define a time range, wherein the time range includes arrival time picks of a reflection event different from a first break, and at least one of the down-going and up-going portions of the VSP data that is processed includes VSP data associated with the reflection event defined by the time range.

12. The method of claim 2, wherein the up-going portion of VSP data is transformed to two-way time.

13. The method of claim 1, wherein the VSP data includes at least one of near zero offset VSP data and walk above VSP data.

14. The method of claim 1, further comprising:
applying the seismic energy to the formation; and
recording the VSP data.

15. A vertical seismic profiling (VSP) system, comprising:
at least one seismic energy source applying seismic energy to a formation undergoing a VSP survey;
at least one receiver defining a plurality of channels disposed below a surface of the formation to output VSP data in response to detecting seismic energy associated with the applied seismic energy; and
a processing system including:
at least one processor; and
a memory coupled to the processor, wherein the memory stores programmable instructions, that when executed by the processor, cause the processor to:
receive vertical seismic profiling (VSP) data in response to seismic energy applied to the formation;
process a down-going portion of the VSP data associated with a down-going wave field;
output a first set of estimation values based on processing the down-going portion of the VSP data, the first set of estimation values estimating at least one of slowness or velocity;
process an up-going portion of the VSP data associated with an up-going wave field;
output a second set of estimation values based on processing the up-going portion of the VSP data, the second set of estimation values estimating at least one of slowness or velocity; and
determine an estimation of at least one velocity and slowness associated with the formation based on the first and second sets of estimation values.

16. The system of claim 15, wherein processing at least one of the down-going portion of the VSP data and the up-going portion of the VSP data comprises applying slant stack analysis to VSP data associated with the range of channels associated with each of the corresponding down-going portion and up-going portion of the VSP data.

17. The system of claim 15, wherein applying the slant stack analysis to at least one of down-going portion of the VSP data and the up-going portion of the VSP data associated with the range of channels includes generating a semblance as a function of slope and time lag of a plurality of ribbons of traces, each ribbon of traces including VSP data associated with a respective ribbon of channels incrementally slid along the range of channels, the slope of one of the ribbon of traces being a slope of arrival times for each trace of the ribbon of traces and the time lag of the ribbon of traces being an arrival time at a first channel in the ribbon of channels,
wherein the semblance is determined based on a summation of the arrival times over the time window for each trace of the ribbon of traces, the arrival times accounting for time lag associated with the slope of the trace of ribbons.

18. The system of claim 17, wherein the programmable instructions, when executed by the processor, further cause the processor to determine a peak semblance value of the semblance, the peak semblance value representing peak coherence associated with each of the up-going and down-going portions of the VSP data that represents a measure of how well the slope of the ribbon of traces fits the VSP data included in the ribbon of traces.

19. A computer system comprising:
a processor:
a memory coupled to the processor, wherein the memory stores programmable instructions, that when executed by the processor, cause the processor to:
receive vertical seismic profiling (VSP) data in response to seismic energy applied to the formation;
process a down-going portion of the VSP data associated with a down-going wave field;
output a first set of estimation values based on processing the down-going portion of the VSP data, the first set of estimation values estimating at least one of slowness or velocity;
process an up-going portion of the VSP data associated with an up-going wave field;
output a second set of estimation values based on processing the up-going portion of the VSP data, the second set of estimation values estimating at least one of slowness or velocity; and
determine an estimation of at least one velocity and slowness associated with the formation based on the first and second sets of estimation values.

20. The information processing system of claim 19, wherein processing at least one of the down-going portion of the VSP data and the up-going portion of the VSP data comprises applying slant stack analysis to VSP data associated with the range of channels associated with the each of the corresponding down-going portion and up-going portion of the VSP data.
